(19) United States
(12) Patent Application Publication
(10) Pub. No.: US 2022/0367858 A1
(43) Pub. Date: Nov. 17, 2022

(54) Electrode Structure and Lithium Secondary Battery Including the Same

(71) Applicant: SK ON CO., LTD., Seoul (KR)

(72) Inventors: Kyung Hee Jeong, Daejeon (KR); Young Im Kwon, Daejeon (KR); Ye Rin Seo, Daejeon (KR); Ga Yeong Yoo, Daejeon (KR)

(21) Appl. No.: 17/740,916

(22) Filed: May 10, 2022

(30) Foreign Application Priority Data
May 11, 2021 (KR) 10-2021-0060644

(51) Int. Cl. H01M 4/36; H01M 4/04; H01M 4/62; H01M 10/052; H01M 4/66

(52) U.S. Cl. CPC H01M 4/366; H01M 4/0404; H01M 4/625; H01M 10/052; H01M 4/662

(57) ABSTRACT

An electrode structure for a secondary battery includes a current collector, a first active material layer formed on at least one surface of the current collector, a second active material layer on the first active material layer, and a conductive intermediate layer interposed between the first active material layer and the second active material layer. The conductive intermediate layer has a resistance lower than each resistance of the first active material layer and the second active material layer. A lithium secondary battery including the electrode structure is provided.

### CROSS-REFERENCE TO RELATED APPLICATION

This application claims priority to Korean Patent Application No. 10-2021-0060644 filed May 11, 2021, the disclosure of which is hereby incorporated by reference in its entirety.

### BACKGROUND OF THE INVENTION

### 1. Field of the Invention

The present invention relates to an electrode structure and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, the secondary battery or a battery pack including the same is being developed and applied as an eco-friendly power source of an electric automobile.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, when the lithium secondary battery is applied to a high-power device such as an electric vehicle, higher capacity and energy generation are required. In this case, an increase of a density and a capacity of an active material included in an electrode may also be required.

When a stability of the secondary battery is increased, a resistance of the electrode may increase, which may be disadvantageous from an aspect of a power of the secondary battery.

Thus, developments for improving both properties of high power (or low resistance) and stability which may be in a trade-off relation as described above may be needed.

For example, as disclosed in Korean Published Patent Application No. 10-2016-0019246, methods for improving stability of the secondary battery are being developed, but sufficient properties for high power and low-resistance may not be provided.

### SUMMARY OF THE INVENTION

According to an aspect of the present invention, there is provided an electrode structure having improved electrical property and mechanical stability.

According to an aspect of the present invention, there is provided a lithium secondary battery including an electrode structure with improved electrical property and mechanical stability.

According to embodiments of the present invention, an electrode structure for a secondary battery includes a current collector, a first active material layer formed on at least one surface of the current collector, a second active material layer on the first active material layer, and a conductive intermediate layer interposed between the first active material layer and the second active material layer. The conductive intermediate layer has a resistance lower than each resistance of the first active material layer and the second active material layer.

In some embodiments, the conductive intermediate layer may be in contact with the current collector.

In some embodiments, the conductive intermediate layer may surround a top surface and lateral surfaces of the first active material layer.

In some embodiments, the conductive intermediate layer may be formed on a top surface and one of lateral surfaces of the first active material layer.

In some embodiments, the conductive intermediate layer may surround a bottom surface and lateral surfaces of the second active material layer.

In some embodiments, the first active material layer may include a plurality of first active material pattern layers.

In some embodiments, the conductive intermediate layer may fill a space between the first active material pattern layers to be in contact with the current collector.

In some embodiments, the electrode structure may further include a third active material layer stacked on the second active material layer. The conductive intermediate layer may include a first portion interposed between the first active material layer and the second active material layer, and a second portion interposed between the second active material layer and the third active material layer.

In some embodiments, the conductive intermediate layer may further include a third portion extending along sidewalls of the first active material layer and the second active material layer to connect the first portion and the second portion.

In some embodiments, the conductive intermediate layer may include a metal or a carbon-based material.

In some embodiments, the conductive intermediate layer may include at least one of carbon nanotube and graphene.

In some embodiments, the conductive intermediate layer may include openings through which a surface of the first active material layer is exposed.

In some embodiments, the conductive intermediate layer may have a stripe pattern structure, a mesh structure or a network structure.

According to embodiments of the present invention, a lithium secondary battery includes a cathode including a lithium metal oxide, and an anode facing the cathode. At least one of the cathode and the anode includes the electrode structure according to embodiments as described above.

An electrode structure according to example embodiments may include a current collector, a first active material layer and a second active material layer formed on the current collector, and a conductive intermediate layer interposed between the first active material layer and the second active material layer. The conductive intermediate layer may have a lower resistance than that of the first active material layer and the second active material layer.

An electrical conductivity in a thickness direction of the active material layer may be improved by the conductive intermediate layer, so that a resistance of the electrode structure may be reduced, and a power property from an electrode may be improved by decreasing a diffusion path of lithium ions. Further, an loading weight of the electrode for a target power may be increased to improve an electrode productivity.

### BRIEF DESCRIPTION OF THE DRAWINGS

FIGS. 1 to 5 are schematic cross-sectional views illustrating electrode structures in accordance with exemplary embodiments.

FIGS. 6 and 7 are schematic plan views illustrating a conductive intermediate layer in accordance with exemplary embodiments.

FIGS. 8 and 9 are a top planar view and a cross-sectional view, respectively, illustrating a secondary battery in accordance with exemplary embodiments.

### DESCRIPTION OF THE INVENTION

According to exemplary embodiments of the present invention, an electrode structure including a plurality of active material layers and a conductive intermediate layer is provided.

Further, a secondary battery including the electrode structure is also provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

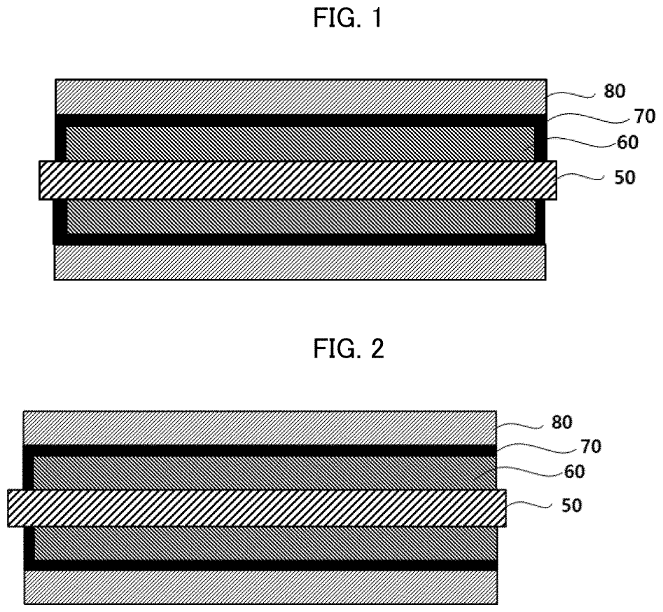

FIGS. 1 to 5 are schematic cross-sectional views illustrating electrode structures in accordance with exemplary embodiments.

Referring to FIG. 1, an electrode structure 10 may include a current collector 50, a first active material layer 60 formed on at least one surface of the current collector 50, a second active material layer 80 formed on the first active material layer 60, and a conductive intermediate layer 70 interposed between the first active material layer 60 and the second active material layer 80.

The current collector 50 may include a metallic material that may not have a reactivity in a voltage range of a secondary battery and may be easily coated with or adhered to an electrode active material. The current collector 50 may include, e.g., stainless steel, nickel, aluminum, titanium, copper, or an alloy thereof. The surface of the current collector 50 may be surface-treated with carbon.

In an embodiment, the current collector 50 may include aluminum or an aluminum alloy and may serve as a cathode current collector. In an embodiment, the current collector 50 may include copper or a copper alloy and may serve as an anode current collector.

The first active material layer 60 may be formed on, e.g., upper and lower surfaces of the current collector 50. The second active material layer 80 may be formed on the first active material layer 60. The first active material layer 60 and the second active material layer 80 may include active material particles and a binder.

In an embodiment, the electrode structure 10 may serve as a cathode of a lithium secondary battery, and the first active material layer 60 and the second active material layer 80 may include a compound capable of reversibly intercalating and de-intercalating lithium ions.

In exemplary embodiments, the cathode active material may include lithium-transition metal oxide particles. For example, the lithium-transition metal oxide particles may include nickel (Ni), and may further include at least one of cobalt (Co) or manganese (Mn).

In exemplary embodiments, the first active material layer 60 and the second active material layer 80 may have the same composition or different compositions.

In exemplary embodiments, the first active material layer 60 may include a high nickel-based lithium oxide having a large nickel content to increase capacity and power properties of the secondary battery, and the second active material layer 80 may include a cathode active material having relatively low nickel content to improve an electrode stability.

In an embodiment, the electrode structure 10 may serve as an anode of the lithium secondary battery, and the first active material layer 60 and the second active material layer 80 may include a carbon-based active material and a silicon-based active material.

The carbon-based active material may include a carbon material particle such as artificial graphite, a crystalline carbon, an amorphous carbon, carbon composite material, carbon fiber. Examples of the amorphous carbon include hard carbon, cokes, mesocarbon microbead (MCMB), mesophase pitch-based carbon fiber (MPCF), etc. Examples of the crystalline carbon include graphitized carbon such as natural graphite, graphitized coke, graphitized MCMB, graphitized MPCF, etc. The anode active material may further include lithium or a lithium alloy together with the carbon-based active material.

The silicon-based active material may include silicon (Si), a silicon alloy, SiOx (0<x<2), or a SiOx (0<x<2) containing a lithium compound. The SiOx containing the Li compound may be a SiOx containing a lithium silicate. The lithium silicate may be present in at least a portion of a SiOx (0<x<2) particle. For example, the lithium silicate may be present at an inside and/or on a surface of the SiOx (0<x<2) particle. In an embodiment, the lithium silicate may include Li₂SiO₃, Li₂Si₂O₅, Li₄SiO₄, Li₄Si₃O₈, etc.

In some embodiments, the silicon-based active material may include a silicon-carbon composite material. The silicon-carbon composite material may include, e.g., silicon carbide (SiC) or a silicon-carbon particle having a core-shell structure.

In exemplary embodiments, the first active material layer 60 and the second active material layer 80 may be the same anode active material composition or different anode active material compositions.

In exemplary embodiments, the first active material layer 60 may include the carbon-based active material as a main active material to increase life-span/stability properties of the secondary battery. The second active material layer 80 may include the silicon-based active material as a main active material so that a lithiation may be promoted from a surface of the anode to sufficiently provide a high-capacity property of the secondary battery.

The binder may include, e.g., an organic binder such as vinylidene fluoride-hexafluoropropylene copolymer (PVDF-co-HFP), polyvinylidenefluoride (PVDF), polyacrylonitrile, polymethyl methacrylate, etc., or an aqueous binder such as styrene-butadiene rubber (SBR) that may be used in a combination with a thickener such as carboxymethyl cellulose (CMC).

In some embodiments, if the electrode structure 10 serves as the cathode 100, the binder may include a PVDF-based binder. If the electrode structure 10 serves as the anode, the binder may include an SBR/CMC binder. In this case, an amount of the binder may be reduced and an amount of the active material may be relatively increased in the first active material layer 60 and the second active material layer 80, thereby improving the power and capacity of the secondary battery.

The conductive intermediate layer 70 may reduce a diffusion path of lithium ions in the electrode between the first active material layer 60/the second active material layer 80 and the current collector 50, and may promote an electron mobility to enhance the power of the secondary battery.

In exemplary embodiments, the conductive intermediate layer 70 may have a resistance less than that of the first second active material layer 60 and the second active material layer 80.

The conductive intermediate layer 70 may include a metal-based material. For example, the conductive intermediate layer 70 may include a metallic material or a metal composite material that may be stable within a driving potential of the electrode active material. For example, the conductive intermediate layer 70 may include copper, copper oxide, tin, tin oxide, titanium oxide, a perovskite material such as LaSrCoO₃, LaSrMnO₃, etc.

In some embodiments, the conductive intermediate layer 70 may include a carbon-based material. For example, the conductive intermediate layer 70 may include graphite, carbon black, graphene, carbon nanotube, etc.

The conductive intermediate layer 70 may further include an active material for forming the above-described first active material layer 60 or second active material layer 80 in addition to the metal-based material and/or the carbon-based material. In this case, the conductive intermediate layer 70 may be more easily formed by, e.g., a coating process.

In some embodiments, the conductive intermediate layer 70 may be in contact with the current collector 50.

In some embodiments, as illustrated in FIG. 1, the conductive intermediate layer 70 may be formed to surround a top surface and lateral surfaces of the first active material layer 60.

Referring to FIG. 2, in some embodiments, the conductive intermediate layer 70 may be formed on or in contact with a top surface and one lateral surface of the first active material layer 60. For example, the conductive intermediate layer 70 may be formed on or in contact with a lateral surface of the first active material layer 60 adjacent to an electrode tab among lateral surfaces of the first active material layer 60.

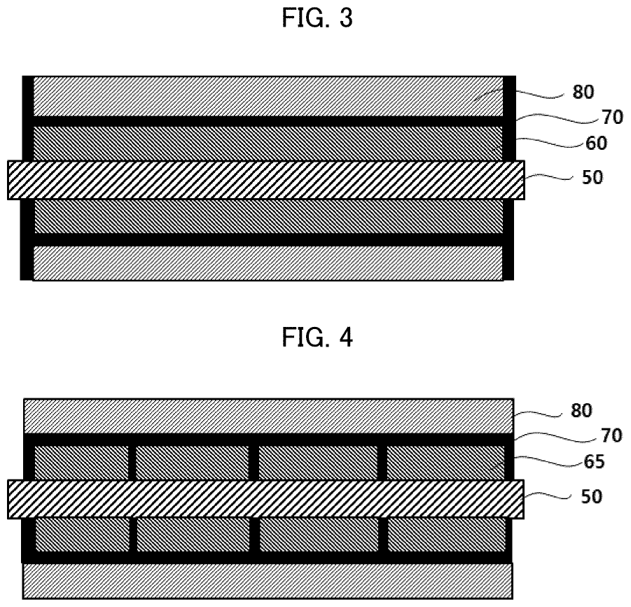

Referring to FIG. 3, in some embodiments, the conductive intermediate layer 70 may be formed to surround a bottom surface and lateral surfaces of the second active material layer 80.

Referring to FIG. 4, in some embodiments, the first active material layer may include a plurality of first active material pattern layers 65, and the conductive intermediate layer 70 may fill a space between the first active material pattern layers 65 to be contact with the current collector 50.

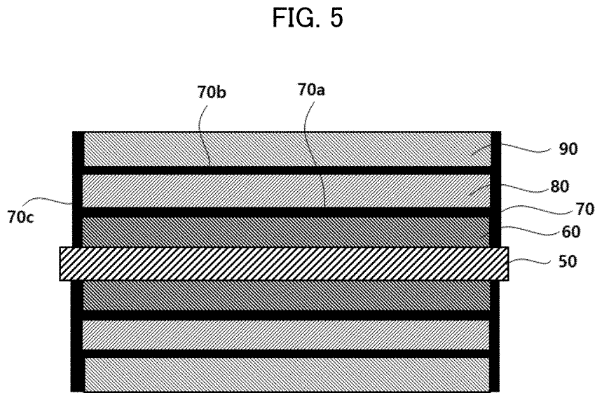

Referring to FIG. 5, in some embodiments, the electrode structure 10 may further include a third active material layer 90 stacked on the second active material layer 80. The conductive intermediate layer 70 may include a first portion 70a disposed between the first active material layer 60 and the second active material layer 80, and a second portion 70b disposed between the second active material layer 80 and the third active material layer 90.

In some embodiments, the conductive intermediate layer 70 may further include a third portion 70c connecting the first portion 70a and the second portion 70b, and extending along sidewalls of the first active material layer 60 and the second active material layer 80.

As described above, the conductive intermediate layer 70 and the active material layer may be further added on the second active material layer 80. The conductive intermediate layer 70 may form an electron transfer path in a thickness direction of the first active material layer 60 and the second active material layer 80.

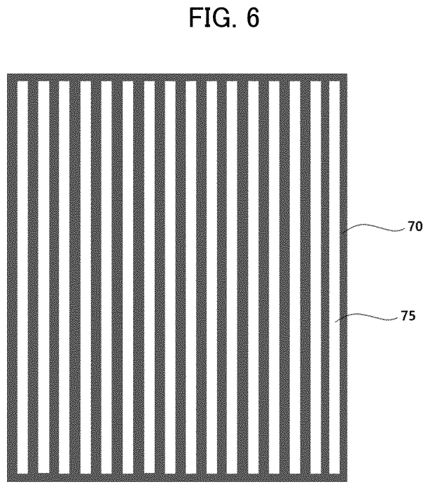

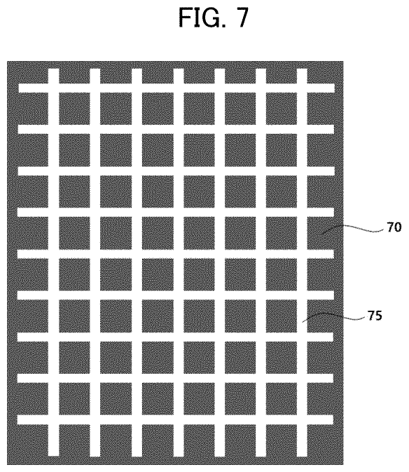

FIGS. 6 and 7 are schematic plan views illustrating a conductive intermediate layer in accordance with exemplary embodiments.

Referring to FIGS. 6 and 7, the conductive intermediate layer 70 may include openings 75 exposing a surface of the first active material layer 60.

In some embodiments, the conductive intermediate layer 70 may have a stripe pattern shape, a mesh structure or a network structure.

The opening 75 may have a shape of, e.g., a straight line, a cross, a circle, an ellipse, a triangle, a square, a pentagon, a hexagon, a stripe, a net, a honeycomb, etc. The first active material layer 60 and the second active material layer 80 may be in direct contact with each other through the openings 75, and structural stability and power properties of the electrode may be further improved.

As described above, according to exemplary embodiments, the conductive intermediate layer 70 may be disposed between the first active material layer 60 and the second active material layer 80, so that a conductivity in the thickness direction of the electrode structure 10 may be increased and the diffusion path and resistance of lithium ions in the electrode may be reduced. Thus, an electrode density and power/capacity of the secondary battery may also be improved.

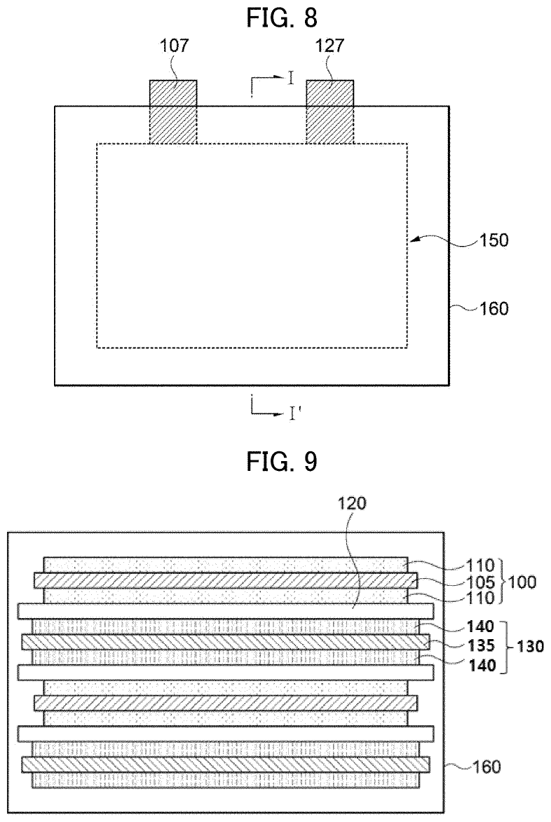

FIGS. 8 and 9 are a top planar view and a cross-sectional view, respectively, illustrating a secondary battery in accordance with exemplary embodiments. For example, FIG. 9 is a cross-sectional view taken along a line I-I′ of FIG. 8 in a thickness direction of the lithium secondary battery.

For convenience of descriptions, illustration of a cathode and an anode is omitted in FIG. 8.

Referring to FIGS. 8 and 9, the lithium secondary battery may include an electrode assembly 150 and a case 160 accommodating the electrode assembly 150. The electrode assembly 150 may include a first electrode 100 and a second electrode 130 physically separated from the first electrode 100 to face the first electrode 100. The second electrode 130 may have a polarity opposite to that of the first electrode 100.

In exemplary embodiments, the first electrode 100 and/or the second electrode 130 may include the electrode structure 10 as described with reference to FIGS. 1 to 6. At least one of the first electrode 100 and the second electrode 130 may include the above-described electrode structure 10.

For example, at least one of an first electrode active material layer 110 and an second electrode active material layer 140 may include a structure of the first active material layer 60, the conductive intermediate layer 70 and the second active material layer 80 as described above.

For example, the first electrode 100 and the second electrode 130 may serve as the cathode and the anode of the secondary battery, respectively. In this case, an area and/or a volume of the second electrode 130 may be greater than that of the first electrode 100. Thus, lithium ions generated from the first electrode 100 serving as the cathode may be easily transferred to the second electrode 130 without a loss by, e.g., precipitation or sedimentation to further improve power and capacity of the secondary battery.

The separation layer 120 may be interposed between the first electrode 100 and the second electrode 130. The separation layer 120 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 120 may also include a non-woven fabric formed from a glass fiber with a high melting point, a polyethylene terephthalate fiber, or the like.

The separation layer 120 may extend in a width direction of the secondary battery between the first electrode 100 and the second electrode 130, and may be folded and wound along the thickness direction of the secondary battery. Accordingly, a plurality of the first electrode 100 and the second electrode 130 may be stacked in the thickness direction using the separation layer 120.

In exemplary embodiments, an electrode cell may be defined by the first electrode 100, the second electrode 130 and the separation layer 120, and a plurality of the electrode cells may be stacked to form the electrode assembly 150 that may have e.g., a jelly roll shape. For example, the electrode assembly 150 may be formed by winding, laminating or folding of the separation layer 120.

The electrode assembly 150 may be accommodated together with an electrolyte in the case 160. The case 160 may include, e.g., a pouch, a can, etc.

In exemplary embodiments, a non-aqueous electrolyte may be used as the electrolyte.

The non-aqueous electrolyte solution may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

Electrode tabs (a cathode tab and an anode tab) may protrude from a first electrode current collector 105 and a second electrode current collector 135 included in each electrode cell to one side of the case 160. The electrode tabs may be welded together with the one side of the case 160 to be connected to an electrode lead (a first electrode lead 107 and a second electrode 127) that may be extended or exposed to an outside of the case 160.

FIG. 8 illustrates that the first electrode lead 107 and the second electrode lead 127 are positioned at the same side of the lithium secondary battery or the case 160, but the first electrode lead 107 and the second electrode lead 127 may be formed at opposite sides to each other.

For example, the cathode lead 107 may be formed at one side of the case 160, and the anode lead 127 may be formed at the other side of the case 160.

The secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

92 wt % of natural graphite as an anode active material, 1.5 wt % of a styrene-butadiene rubber (SBR)-based binder, 1.5 wt % of CMC as a thickener, and 5 wt % of a flake-type amorphous graphite as a conductive material were mixed and uniformly dispersed to form an anode slurry. The anode slurry was coated, dried and pressed on a copper current collector to form a first active material layer. A carbon nanotube-added paste was coated on the first active material layer and dried to form a conductive intermediate layer to be connected to the current collector. The conductive intermediate layer was formed to surround a top surface and lateral surfaces of the first active material layer. Thereafter, the anode slurry was coated again on the conductive intermediate layer, dried and pressed to form a second active material layer and obtain an anode.

### Example 2

An anode was fabricated by the same method as that in Example 1, except that the conductive intermediate layer was formed to be in contact with the top surface and a lateral surface at a side for a formation of an anode tab of the first active material layer as illustrated in FIG. 2.

### Example 3

An anode was fabricated by the same method as that in Example 1, except that the conductive intermediate layer was further formed to surround lateral surfaces of the second active material layer after the formation of the second active material layer as illustrated in FIG. 3.

### Example 4

An anode was fabricated by the same method as that in Example 1, except that the first active material layer was formed to include a plurality of pattern layers through which the current collector was exposed, and the conductive intermediate layer was formed to fill spaces between the pattern layers as illustrated in FIG. 4.

### Example 5

An anode was fabricated by the same method as that in Example 1, except that the conductive intermediate layer was additionally formed by coating and drying a mixture of metal-based particles, carbon nanotube and graphene on the second active material layer of Example 1, and then a third active material layer having the same material and structure as those of the second active material layer was formed on the conductive intermediate layer.

### Example 6

An anode was fabricated by the same method as that in Example 1, except that the conductive intermediate layer was formed on the first active material layer as stripe patterns, and then the second active material layer was formed thereon.

### Comparative Example

An anode was fabricated by the same method as that in Example 1, except that the first active material layer was only formed on the current collector.

### Experimental Example: Evaluation of Anode Resistance

A bulk resistance of each anode of Examples and Comparative Example was measured.

Specifically, in the anodes prepared to have the same entire thickness, five points were punched in a thickness direction, and a resistance was measured five times. The electrode resistance was measured by averaging remaining measured values except for maximum and minimum values among the measured values. The electrode resistance was measured using a HIOKI electrode resistance meter (4-probe).

A resistance reduction ratio was calculated through Equation 1 below based on an electrode resistance value of Comparative Example.

Resistance reduction ratio (%)=((R_{ref}−Rₑₓ)/R_{ref})×100 [Equation 1]

In Equation 1, R_{ref} is an electrode resistance of Comparative Example, and Rₑₓ is an electrode resistance of each of Examples

The results are shown in Table 1 below.

TABLE 1

| | | Resistance Reduction |
|---|---|---|
| | Electrode Resistance | Ratio |
| No. | (mΩ) | (%) |
| Example 1 | 0.090 | 25.0 |
| Example 2 | 0.090 | 25.0 |
| Example 3 | 0.088 | 26.7 |
| Example 4 | 0.083 | 30.8 |
| Example 5 | 0.085 | 29.2 |
| Example 6 | 0.088 | 26.7 |
| Comparative | 0.120 | — |
| Example | | |

What is claimed is:

1. An electrode structure for a secondary battery, comprising:
a current collector;
a first active material layer formed on at least one surface of the current collector;
a second active material layer on the first active material layer; and
a conductive intermediate layer interposed between the first active material layer and the second active material layer, the conductive intermediate layer having a resistance lower than each resistance of the first active material layer and the second active material layer.

2. The electrode structure for a secondary battery of claim 1, wherein the conductive intermediate layer is in contact with the current collector.

3. The electrode structure for a secondary battery of claim 2, wherein the conductive intermediate layer surrounds a top surface and lateral surfaces of the first active material layer.

4. The electrode structure for a secondary battery of claim 2, wherein the conductive intermediate layer is formed on a top surface and one of lateral surfaces of the first active material layer.

5. The electrode structure for a secondary battery of claim 2, wherein the conductive intermediate layer surrounds a bottom surface and lateral surfaces of the second active material layer.

6. The electrode structure for a secondary battery of claim 1, wherein the first active material layer comprises a plurality of first active material pattern layers.

7. The electrode structure for a secondary battery of claim 6, wherein the conductive intermediate layer fills a space between the first active material pattern layers to be in contact with the current collector.

8. The electrode structure for a secondary battery of claim 1, further comprising a third active material layer stacked on the second active material layer,
wherein the conductive intermediate layer comprises a first portion interposed between the first active material layer and the second active material layer, and a second portion interposed between the second active material layer and the third active material layer.

9. The electrode structure for a secondary battery of claim 8, wherein the conductive intermediate layer further comprises a third portion extending along sidewalls of the first active material layer and the second active material layer to connect the first portion and the second portion.

10. The electrode structure for a secondary battery of claim 1, wherein the conductive intermediate layer comprises a metal or a carbon-based material.

11. The electrode structure for a secondary battery of claim 10, wherein the conductive intermediate layer comprises at least one of carbon nanotube and graphene.

12. The electrode structure for a secondary battery of claim 1, wherein the conductive intermediate layer comprises openings through which a surface of the first active material layer is exposed.

13. The electrode structure for a secondary battery of claim 12, wherein the conductive intermediate layer has a stripe pattern structure, a mesh structure or a network structure.

14. A lithium secondary battery, comprising:
a cathode comprising a lithium metal oxide; and
an anode facing the cathode,
wherein at least one of the cathode and the anode comprises the electrode structure for a secondary battery according to claim 1.
